(19) United States
(12) Patent Application Publication
(10) Pub. No.: US 2016/0199749 A1
(43) Pub. Date: Jul. 14, 2016

(54) Magnetic Panel System and Method to Fabricate

(71) Applicant: Jeffrey Blane Whittaker, Dearborn, MI (US)

(72) Inventor: Jeffrey Blane Whittaker, Dearborn, MI (US)

(21) Appl. No.: 14/875,609

(22) Filed: Oct. 5, 2015

Related U.S. Application Data
(63) Continuation-in-part of application No. 14/042,749, filed on Oct. 1, 2013, now abandoned.

(51) Int. Cl. A63H 33/04; G09B 23/26; H01F 7/02

(52) U.S. Cl. CPC A63H 33/046; H01F 7/0252; G09B 23/26

(57) ABSTRACT

A magnetic panel system for the construction of structures is disclosed that includes sets of polygonal connector bodies, constructed of plastic or other suitable material, that have corners, edges, and endpoints of rods that are substantially rounded. Hollow, spherical sockets are defined in the corners of the connector bodies with spherical magnets contained therein. The free rotation around any axis that is provided by spherical magnets within spherical sockets assures alignment of magnet fields and mutual attraction of adjacent bodies in many configurations including face-to-face, edge-to-edge, and corner-to-corner combinations, something unavailable with other magnet shapes. Furthermore, equal spacing of sockets in bodies assures magnets are in consistent proximity to other magnets in adjacent bodies. Because spherical magnets adjust within the socket in any direction to form a connection with the greatest magnetic force, the polygonal connector bodies is robust and can be assembled readily making this suitable for young children.

### FIELD

The present disclosure relates to magnetic construction toys.

### BACKGROUND

Toy stores sell a range of magnetic construction sets. One design is shown by Vincentelli (EP 1349626 B1). Vincentelli shows plastic rods that have cylindrical magnets fixed in each end. Spheres of a ferromagnetic material are provided to be the attachment point between magnetic rods. The Vincentelli disclosure suffers several deficiencies. The resulting structures have low structural strength due to the shifting of angles between adjacent magnetic rods. Furthermore, the construction toy of Vincentelli is inappropriate for younger children because the pieces are too small for younger children and because to build anything of consequence requires a large number of rod and metal spheres that is more complex and time consuming than most young children can manage.

Bong-Seok Yoon (U.S. Pat. No. 7,160,170) describes polygonal bodies incorporating magnets which are loosely contained in compartments. The loosely held magnets doesn't promote even alignment of adjacent panels, a necessary condition for accurate construction of structures that will allow building multiple levels without collapsing.

Hunts (U.S. Pat. No. 7,154,363) discloses a magnetic connector apparatus to connect two or more bodies with diametrically magnetized cylindrical magnets. In Hunts, the cylindrical magnets are housed within a cylindrical container that allows the cylindrical magnets to rotate about its z-axis, but prevents rotation in any other axis. Such an arrangement is suitable for connecting two or more bodies along linear borders, but is ill suited for more complicated arrangements as will be discussed below in further detail.

### SUMMARY

A magnetic apparatus is disclosed that has: a first polygonal connector body having sockets defined in at least three corners of the connector body, a second polygonal connector body having spherical sockets defined in at least two corners of the connector body, and magnets disposed in each of the sockets. The magnets are free to rotate within their respective sockets around an x-axis, a y-axis, a z-axis, and any combination of the x, y, and z axes. The first polygonal connector body abuts the second polygonal connector so that a first magnet disposed within the first polygonal body is proximate a second magnet disposed within the second polygonal body. The first and second magnets are free to rotate within their associated sockets to minimize external magnetic field. That is, the attractive force between the first and second magnets are maximized with the constraint of being within their respective sockets.

In some embodiments, the first polygonal connector body has two flat sections each defining a hemispherical portion of each of the spherical sockets. Each flat section has at least two pins and two receptacles, with two pins of the first polygonal connector body engaging with two receptacles of the second polygonal connector body and two pins of the second polygonal connector body engaging with two receptacles of the first polygonal connector body.

The magnets are spherical and have a first radius. The spherical sockets have a second radius. The first radius is less than the second radius.

An outer surface of the polygonal connector body proximate at least one of the corners is curved concentrically with respect to the spherical socket proximate the corner.

When only one corner of the first polygonal body is coupled to a corner of the second polygonal body, the second polygonal body may freely rotate with respect to the first polygonal body.

Some embodiments include an opening defined in the center of the first polygonal connector body.

In some embodiments, particularly those having larger polygonal connector bodies, the first polygonal body has an additional socket defined in an edge of the first polygonal body between two sockets defined in adjacent corners of the first polygonal body. A magnet is provided in the additional socket.

A distance between two sockets along a first side in the first polygonal body is equal to a distance between two sockets in a first side of the second polygonal body. Magnets within the two sockets of the first and second polygonal bodies attract each other when the first sides of the first and second polygonal bodies are brought proximate to each other regardless of the orientation of the first and second polygonal bodies.

Also disclosed is a magnetic construction apparatus having at least two magnetic connector bodies adapted to magnetically connect one to another. Each magnetic connector body has a plurality of spherical sockets defined within the corners of the magnetic connector body. A spherical permanent magnet is disposed in each of the sockets with clearance provided between the spherical socket and the spherical permanent magnet. The clearance allows the spherical permanent magnet to freely rotate around an x-axis, a y-axis, a z-axis, and any combination of the x, y, and z axes.

An outside surface of at least one of the corners of the body is substantially concentrically curved with respect to the socket.

The sockets have a first radius and at least one of the corners of the connector bodies has a second radius, the second radius is greater than the first radius; and the center of the socket and the center of curvature of the at least one of the corners are substantially coincident.

Some connector bodies having an opening defined in the center.

In some embodiments, each of the magnetic connector bodies is comprised of two sections that snap together.

In some embodiments, the two sections have internal strengthening ribs.

In some embodiments, the magnetic connector bodies are used to represent chemical atoms with at least one of the following denoting atom type: a letter printed on the bodies, a shape of the bodies, and a surface finish of the bodies.

Also disclosed is a method to manufacture a magnetic connector apparatus by fabricating two sections of a polygonal connector body with each of the two sections having hemispherical sockets defined in at least three corners of each section, placing spherical magnets into the hemispherical socket portions in a first of the two sections, the spherical magnets are free to rotate within their respective sockets around and x-axis, a y-axis, a z-axis, and any combination of the x, y, and z axes, positioning a second of the two sections over the first section such that the hemispherical socket portions of the two sections are mutually aligned, placing the second of the two sections on the first section, and snapping the first section with the second section.

Each of the two sections have a plurality of receptacles and pins. When placing the second of the two sections on the first section, a first of the pins of the first section engages with a first of the receptacles of the second section and a first of the receptacles of the first section engages with a first of the pins of the second section.

In some embodiments, the two sections of the polygonal connector body are fabricated by injection molding.

In some embodiments, an opening is defined in the center section of the polygonal connector body to thereby reduce the amount of material used in fabricating the polygonal connector body.

The sections of the polygonal connector body may have a plurality of internal strengthening ribs.

Spherical magnet present a great advantage over other magnet shapes for several reasons. The spherical magnet, when inside a spherical socket that provides a small amount of clearance, can rotate around any axis. This allows two magnets that are in close proximity to align themselves so that magnetic force is maximized. Some magnet configurations have ability to adjust, such as a cylindrical magnet in which one end is a north pole and the other end is a south pole. With a cylindrical magnet that is diametrically magnetized, the magnet can rotate along one axis only. Such magnets provide do not provide strong attraction. Furthermore, they may limit the configurations that can be built. Finally, by rounding corners of the bodies, the spherical magnets can get very close to a spherical magnet in another connector body. Other magnet shapes don't allow such close proximity. Also, if two connector bodies are connected corner to corner, one of the bodies can spin with respect to the other, something not possible with other magnet shapes.

By having the magnets provided at the corners of the connector bodies, a more robust structure can be constructed than with some prior art connector bodies in which the magnets are provided in the center of the sides.

The magnetic connector bodies provide an educational toy that allows construction of structures for young children without the frustration of some prior art systems. In some embodiments, the bodies have openings in the center which can give a small child a place to grab the connector body to aid in frustration-free handling.

### BRIEF DESCRIPTION OF THE DRAWINGS

FIGS. 1-4, 6-8, 12, and 22-26 are illustrations of polygonal connector bodies according to embodiments of the disclosure;

FIG. 5 is an illustration of a spherical magnet showing degrees of freedom of rotation;

FIGS. 9-11 are illustrations of proximate spherical magnets and the direction of their magnetic attractive forces;

FIG. 13-21 are illustrations of alternative arrangements of magnets in polygonal connector bodies used to contrast with the embodiments of the disclosure;

FIG. 27 is a flowchart;

FIGS. 28-30 are illustrations of polygonal connector bodies arranged to represent molecules.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

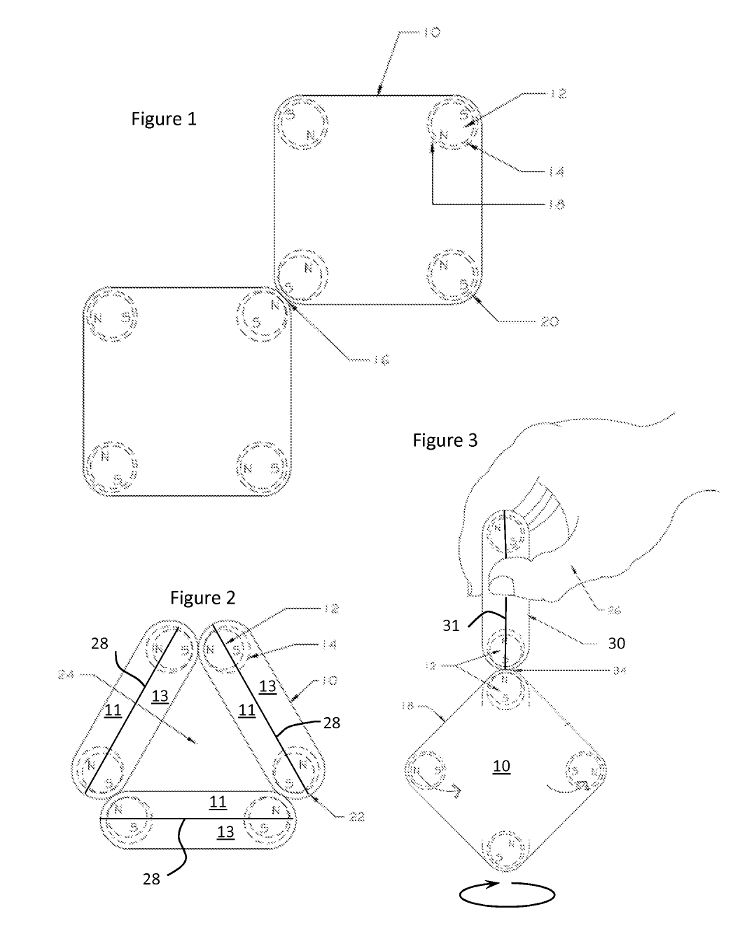

FIG. 1 shows an embodiment of the present disclosure. Spherical magnets 12 are housed with a clearance 14, within spherical sockets 18 which are within polygonal connector bodies 10. Corners 20 of the polygonal bodies 10 are curved and have a radius that is slightly larger than the radius of sockets 18 which are in turn slightly larger than the radius of magnets 12. As polygonal bodies 10 are moved toward each other, spherical magnets 12 in adjacent sockets 18 rotate freely within spherical sockets 18 to align N and S poles of magnets and exert mutual force of attraction to each other. In some embodiments, corners 20 are curved so that there is a small separation distance to provide relatively strong mutual force of attraction between polygonal connector bodies 10 in a corner-to-corner connection 16.

FIG. 2 shows an end view a plurality of polygonal connector bodies 10. Spherical magnets 12 are housed within spherical sockets 14 of polygonal connector bodies 10. Polygonal connector bodies are substantially rounded corners 22. A plurality of edge-connected bodies form a ring-like structure with an open interior 24. In some embodiments, polygonal connector bodies 10 include two sections 11 and 13 that are snapped together. A joint 28 shows the place where sections 11 and 13 abut each other.

In FIG. 3, a bar 30 that has magnets 12 in both ends. A corner of polygonal connector body 10 is placed proximate an end of bar 30. Bar 30 is also made from two sections as suggested by joint 31. When a torque is imparted to body 10, it spins freely with respect to bar 30 that is held fixed by hand 26. This is facilitated by magnets 12 being freely rotatable in sockets 14 and by the corners at interface 34 being rounded that allow the magnets to get close to each other and to attain a position that maximizes the attractive force. A similar effect would occur if hand 26 was holding a body 10 with a corner of the body abutting a corner of another body.

A polygonal connector body 40 is shown in FIG. 4. It is square, except for rounded corners. Sockets 42 are provided in each corner. A magnet is provided in each socket 42. The diameter of socket 42 is slightly larger than the diameter of magnet 44 to ensure that magnet 44 can freely rotate in socket 42. Corners 45 are curved with a radius greater than the radii of socket 42 and magnet 44. A center of the radius associated with curve 45 is substantially coincident with a center of socket 42. The position of magnets 44 in FIG. 4 is arbitrary. They could be in any position.

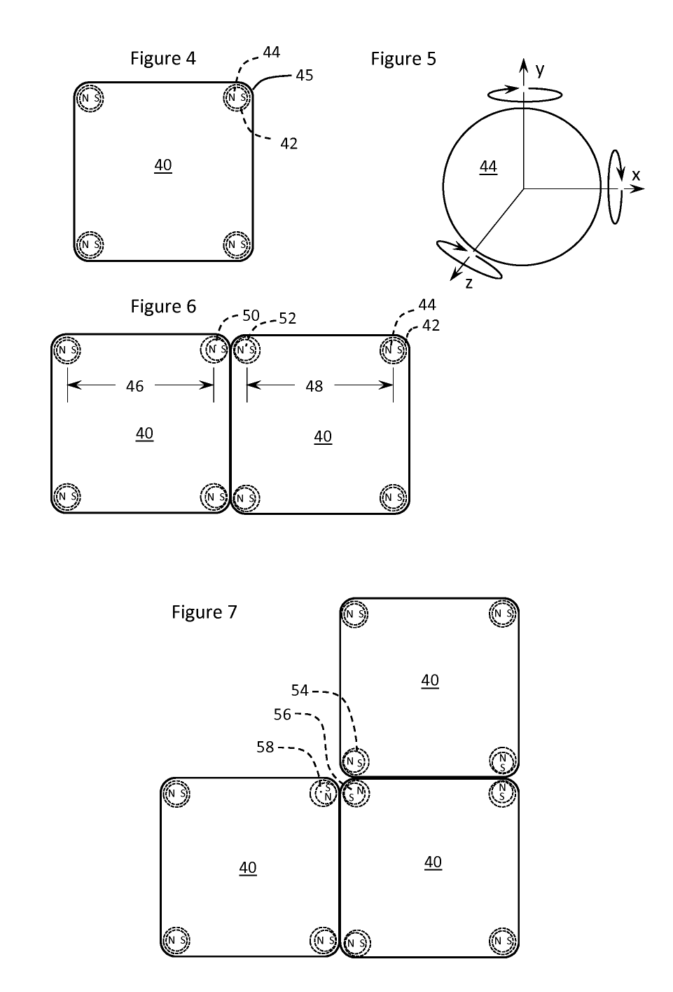

In FIG. 5, a magnet 44 is shown with x, y, and z axes. When magnet 44 is within socket 42, it may freely rotate about any of combination of the x, y, and z axes.

In the successive figures, the position of proximate magnets is explored as bodies are put together to form a larger construction. In FIG. 6, edges of two bodies 40 are brought proximate to each other. Magnets 50 and 52 move within sockets 44 so that they bump against the edge of its associated socket due to their mutual attraction. It is shown that the S portion of magnet 50 is proximate the N portion of magnet 52. This is just an example and it could be the opposite polarity. Distance between sockets is standardized such that distances 46 and 48, as well as distances between all adjacent sockets in bodies 40.

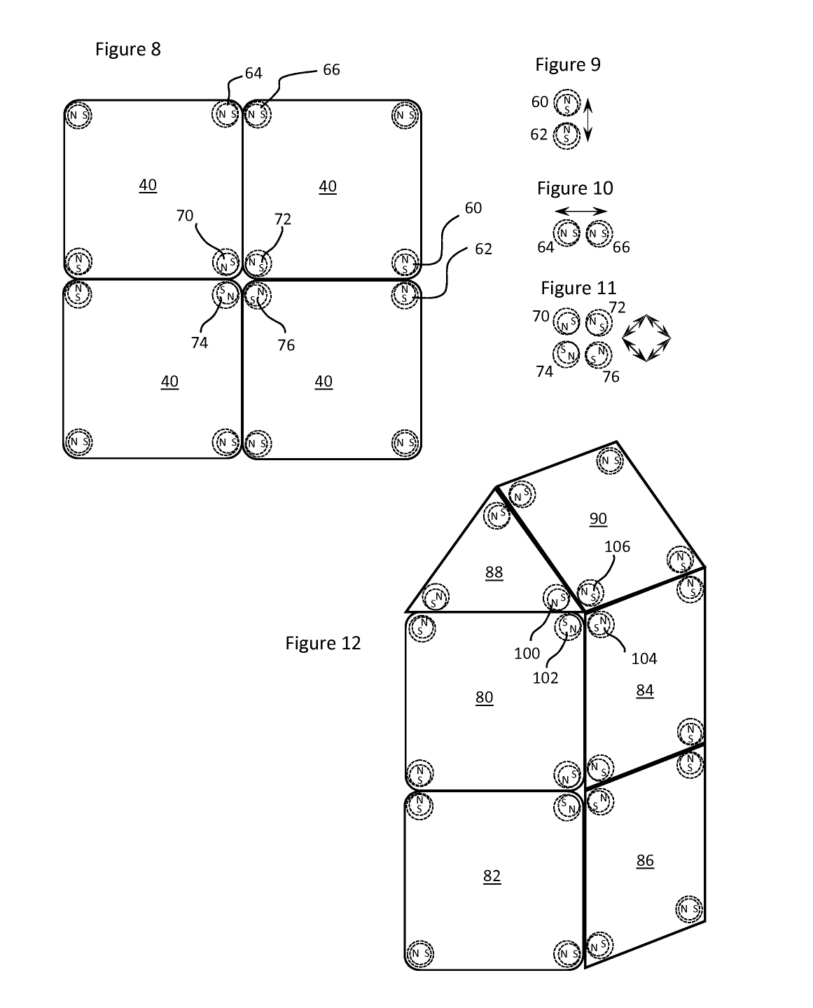

In FIG. 7, a third body 40 is added to the first two bodies. Magnets 54, 56, and 58 move to the edge of their respective sockets to cause them to be as close as possible. Furthermore, magnets 54, 56, and 58 rotate within the sockets to arrange themselves to maximize the attraction or to put it another way, to minimize the external magnetic field. In FIG. 8, four bodies 40 are abutting each other. Magnets 64 and 66 are arranged horizontally and attract each other. Magnets 60 and 62 are arranged vertically and attract each other. Magnets 70, 72, 74, and 76 arrange themselves into a small square. The north and south poles arrange themselves on a diagonal to maximize the force of attraction between them. In FIGS. 9, 10, and 11, the vertical magnetic force, the horizontal magnetic force, and the diagonal forces among four magnets 70, 72, 74, and 76 are shown.

FIG. 8 shows four bodies 40. However, for the purposes of being a construction toy for young children, the ability to build larger, more interesting shapes is desired. Referring now to FIG. 12, a house is shown with bodies 80, 82, 84, 86, 88, and 90 visible. All of the visible bodies are square, except for equilateral triangle 88. Magnets 100, 102, 104, and 106 arrange themselves in a 3-dimensional arrangement that minimizes external magnetic field (to maximize the attractive forces between them. Corners of bodies 84, 86, 88, and 90 are shown as being pointed rather than curved. In an alternative embodiment, they can be curved similar to bodies 80 and 82.

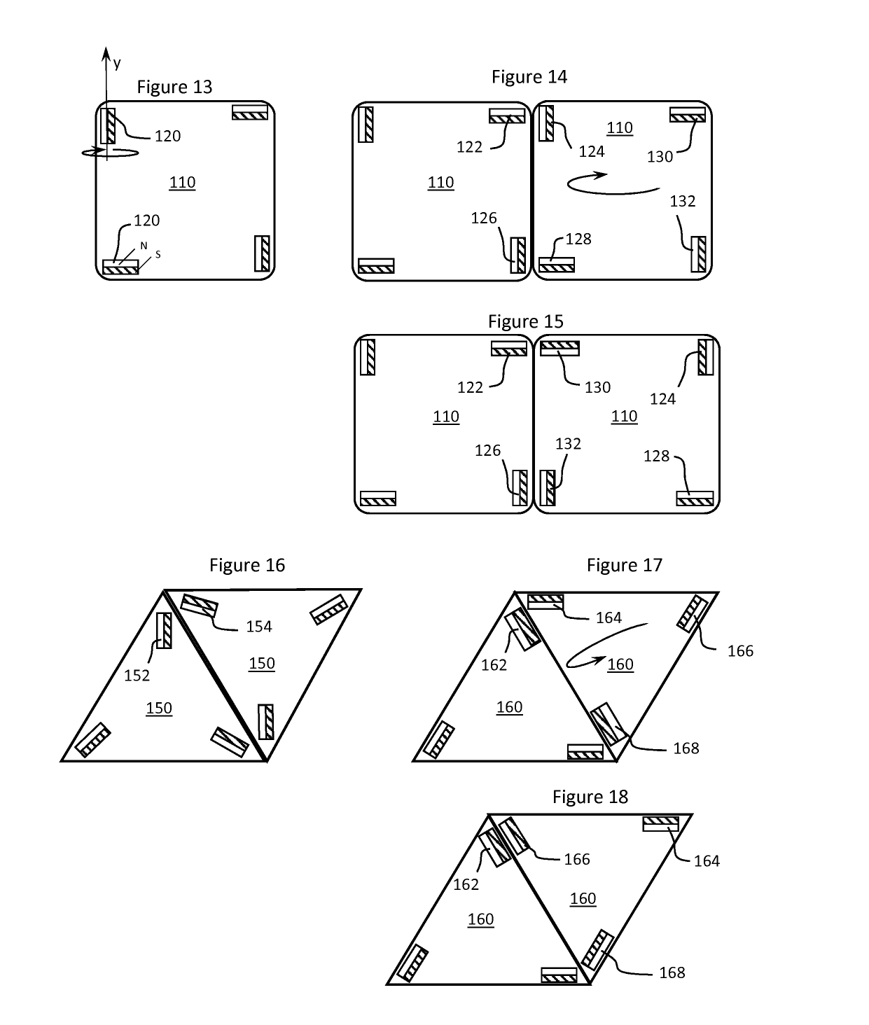

It is not an accident that the inventor of the present disclosure has shown spherical magnets in the construction bodies. An inferior alternative is shown in FIG. 13, in which a body 110 has bodies that have cylindrical magnets 120 that are diametrically polarized. It is common to consider a cylindrical magnet in which one end is a north end and the opposite end is south. However, such a magnet that is within a socket has only the ability to adjust itself axially within the clearance of the socket. (Sockets are not shown separately in FIGS. 13-18, but can be envisioned to be cylindrical with the diameter and length slightly greater than the diameter and length of the cylindrical magnets to allow clearance.) A diametrically polarized cylindrical magnet can rotate within its socket along an axis, such as the y axis shown in FIG. 13.

In FIG. 14, two bodies are brought together and there is no orientation of magnets 122 and 124 that provides a strong attractive force. Magnet 122 presents both north and south poles to magnet 124, thereby both repelling and attracting magnet 124.

In FIG. 15, the right hand body 110 of FIG. 14 is rotate 180 degrees to attain the position in FIG. 15. In such a configuration, magnets 122 and 130 can rotate along their access so that the north of 122 is aligned with the south of 130 and the north of 130 is aligned with the south of 122. Magnets 126 and 132 can also rotate to obtain a strong magnetic pole. Thus, although body 110 can be rotated for favorable attraction between the two bodies 110. However, as the magnetic connector apparatus is targeted for young children, it is undesirable to require the child to flip the body over to facilitate connection. Such a situation will undoubtedly frustrate a child.

One skilled in the art might suggest that all four magnets be placed in the body with the axis of the cylindrical magnets parallel. If two square bodies are brought proximate each other with all magnets parallel, the magnets will adjust themselves to cause the two bodies to stay together. However, if one of the panels is rotated 90 degrees with respect to the other, such that the magnets are vertical in one of the panels and horizontal in the other panel, the magnets proximate each other will be in the position of the magnets 122 and 124 in FIG. 14. Again, such a situation would frustrate a child when trying to build something and finding that about half the time, two bodies won't attract each other.

Things are even worse when the polygonal connector bodies are other than squares. Triangles are shown in FIG. 16. If the cylindrical magnets in equilateral triangular bodies 150 are pointing toward the corners, little magnetic force is generated between proximate magnets 152 and 154. In FIG. 17, the cylindrical magnets are placed parallel to one of the sides of bodies 160. When edges of two triangular bodies 160 are placed next to each other, there is a weak force acting to pull bodies 160 together. By rotating one of the bodies, a more favorable position, as shown in FIG. 18, can be accessed. Again, the solution is undesirable as it would frustrate a child in having only some of positions providing the desired force to facilitating fabricating structures.

In the present disclosure, at least some of the magnets are provided in corners of the polygonal bodies. A polygonal body 180 is shown in FIG. 19 that has magnets 182 disposed in the middle of each side. Such a configuration in which there are no magnets in the corners is inferior for construction as illustrated in FIG. 20. Two bodies 180 are brought together along an edge and only one pair of magnets 186 and 188 are proximate each other. In comparison, two bodies 40 of FIG. 6 have two magnet pairs attracting each other. Thus, there is twice as much force pulling the two bodies together in the configuration in FIG. 6 as in FIG. 19.

Another problem with the configuration of bodies 180 is illustrated in FIG. 21, an end view of bodies 180 that are stacked one on top of the other. Joint 190 is visible in the end view in FIG. 21. Because bodies 180 are only constrained at one point, i.e., by the force between magnets 186 and 188, the two bodies can readily rotate with respect to each other, such as shown in FIG. 21, which does not provide a stable construction base.

Two polygonal bodies 200 that have magnets disposed in the corners have the force of two pairs of magnets holding them together along one edge, as shown in FIG. 22. In FIG. 23, an end view of polygonal bodies 200 of FIG. 22 is shown. Bodies 200 do not rotate with respect to each other because they are constrained at both ends, which provides a stable base for further construction.

Bodies 200 of FIG. 22 has a central opening 240. This can be useful in managing the cost by using less material for each body 200. Additionally, bodies 200 are lighter weight, which are easier for smaller children to handle. Opening 240 can provide a convenient hand hold for construction purposes.

A body 210, shown in FIG. 24, has magnets at the corners and along each side. Particularly for bodies that are larger in size, more magnets may be provided along the sides to provide a greater magnetic force.

In some embodiments, the bodies are fabricated out of two sections that are coupled together. A single section of a polygonal connector body is shown in FIG. 25. Sockets 222 are provided at the corners of section 220 of a body. Sockets 222 are hemispheres. Hemispherical socket 222 of section 220 mates with a hemispherical socket in another section to form the spherical socket.

Ribs 224, 226, and 228 are provided to strengthen section 220, as illustrated in FIG. 25. The desired strength can be provided by making the walls thicker or by using the ribs. To limit the amount of material, it is preferred to put in ribs. To hold two sections together, pins 242 are provided that snap into receptacles 240.

In FIG. 26, an end view of two sections 300 of a body are shown. Hemispherical sockets 302 are provided at the corners. Spherical magnets 304 are placed in the hemispherical sockets 302 of the lower one of sections 300. Receptacles 306 and pins 308 are provided in both of sections 300. A receptacle 306 in the upper of sections 300 is aligned with a pin 308 in the lower of sections 300 and vice versa. When they are aligned, the upper of sections 300 is pushed down onto the lower of sections 300 so that aligned pins 308 engage with receptacles 306. By judicious choice of the locations of pins 308 and receptacles 306, sections 300 are identical, so that both of sections 300 are made in a single die.

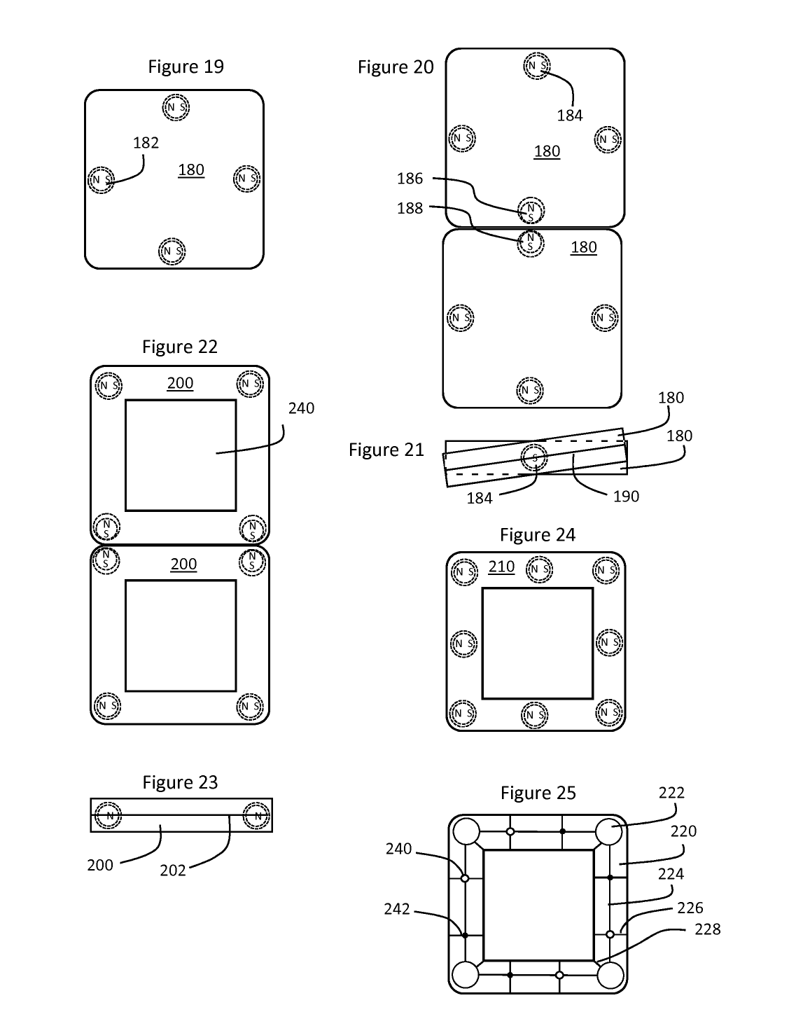

A process for fabricating a polygonal connector body is shown in FIG. 27. In block 500, two sections of the body are fabricated. A common way to make such parts is by injection molding. However, this is just one non-limiting example. One of the sections is placed horizontally in block 502. Magnets are placed into the hemispherical sockets of the first section in block 504. The second section is positioned over the first section aligning pins, receptacles, and hemispherical sockets in block 50. The second section is moved downward so that the pins and the receptacles snap together in block 508.

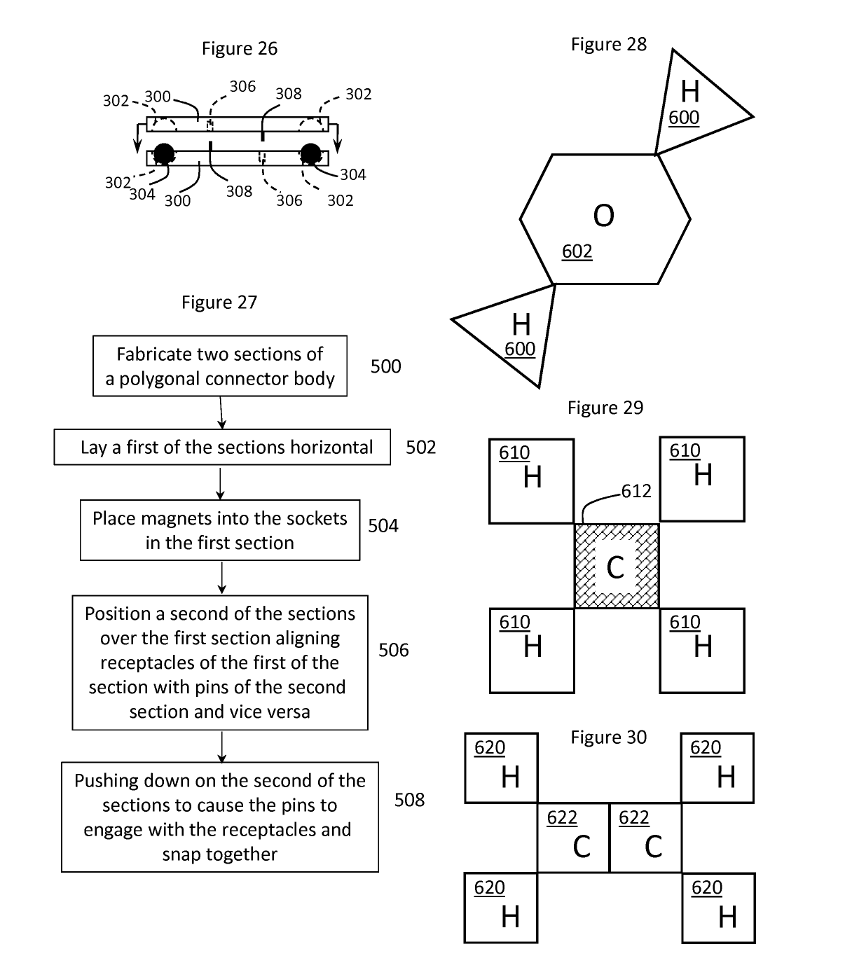

Referring now to FIG. 28, polygonal connector bodies are provided with letters that refer to chemical elements to introduce young children or even those studying high school chemistry to the concept of chemical bonds in molecules. To introduce the chemical makeup of water, H2O, two polygonal connector bodies 600 has a letter H, for hydrogen, printed on the face. Between bodies 600 is a polygonal connector body 602 with the letter O, for oxygen. Bodies 600 are triangles and body 602 is a hexagon. Besides using the letters for identification, the type of polygon can be an indicator for the element. Oxygen has two free electrons each of which shares with one of the hydrogens, which each has a single free electron. To denote sharing of a single electron pair between O and H, the connection is shown as occurring at a point. In FIG. 29, a representation for the molecule methane, CH4, is illustrated. Each of the four free electrons in carbon, C, body 612, bond with a hydrogen, H, body 610. The single bond is denoted by the hydrogen 610 attaching at a corner of the carbon atom 612. Bodies 610 are squares with H's on them to denote hydrogen; and body 612 is a square with a C on it denoting carbon. In some embodiments, bodies 610 are a first color and body 612 is a second, different color. Colors can be used to identify the various atoms making up the molecule. In some embodiments, texture or surface pattern of the bodies is used to indicate the different atom types. Hydrogen (bodies 610 in FIG. 29) can be smooth and carbon (body 612) can have a grid pattern, as one non-limiting example. Referring now to FIG. 30, an ethane molecule, C2H4, is illustrated. The two carbons 622 share a double bond which leaves two other electrons to be shared with two hydrogens 620 in single bonds. The double bond between the two carbons is shown as an edge-to-edge connection. The single bond between the carbons and their respective hydrogen atoms is illustrated by a point-to-point connection.

It is common for white boards in classrooms to be ferromagnetic so that magnetized elements can adhere to the white board. The polygonal connector bodies in FIGS. 28-30 can be placed on such a white board to maintain their respective positions.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

I claim:

1. A magnetic connector apparatus, comprising:
a first polygonal connector body having sockets defined in at least three corners of the connector body;
a second polygonal connector body having spherical sockets defined in at least two corners of the connector body; and
magnets disposed in each of the sockets wherein:
the magnets are free to rotate within their respective sockets around an x-axis, a y-axis, a z-axis, and any combination of the x, y, and z axes;
the first polygonal connector body abuts the second polygonal connector so that a first magnet disposed within the first polygonal body is proximate a second magnet disposed within the second polygonal body; and
the first and second magnets rotate within their associated sockets to minimize external magnetic field.

2. The magnetic connector apparatus of claim 1 wherein:
the first polygonal connector body is comprised of two flat sections each defining a hemispherical portion of each of the spherical sockets;
each flat section has at least two pins and two receptacles, with two pins of the first polygonal connector body engaging with two receptacles of the second polygonal connector body and two pins of the second polygonal connector body engaging with two receptacles of the first polygonal connector body.

3. The magnetic connector apparatus of claim 1 wherein the magnets are spherical and have a first radius; the spherical sockets have a second radius; and the first radius is less than the second radius.

4. The magnetic apparatus of claim 1 wherein an outer surface of the polygonal connector body proximate at least one of the corners is curved concentrically with respect to the spherical socket proximate the corner.

5. The magnetic apparatus of claim 4 wherein when only one corner of the first polygonal body is coupled to a corner of the second polygonal body, the second polygonal body may freely rotate with respect to the first polygonal body.

6. The magnetic apparatus of claim 1 wherein: an opening is defined in the center of the first polygonal connector body.

7. The magnetic connector apparatus of claim 1 wherein the first polygonal body has an additional socket defined in an edge of the first polygonal body between two sockets defined in adjacent corners of the first polygonal body; the magnetic connector apparatus further comprising: a magnet in the additional socket.

8. The magnetic connector apparatus of claim 1 wherein:
a distance between two sockets along a first side in the first polygonal body is equal to a distance between two sockets in a first side of the second polygonal body; and
magnets within the two sockets of the first and second polygonal bodies attract each other when the first sides of the first and second polygonal bodies are brought proximate to each other regardless of the orientation of the first and second polygonal bodies.

9. A magnetic construction apparatus, comprising:
at least two magnetic connector bodies adapted to magnetically connect one to another, each magnetic connector body having a plurality of spherical sockets defined within the corners of the magnetic connector body; and
a spherical permanent magnet disposed in each of the sockets with clearance provided between the spherical socket and the spherical permanent magnet wherein the clearance allows the spherical permanent magnet to freely rotate around an x-axis, a y-axis, a z-axis, and any combination of the x, y, and z axes.

10. The magnetic connector apparatus of claim 9 wherein an outside surface of at least one of the corners of the body is substantially concentrically curved with respect to the socket.

11. The magnetic connector apparatus of claim 9 wherein the sockets have a first radius and at least one of the corners of the connector bodies has a second radius; the second radius is greater than the first radius; and the center of the socket and the center of curvature of the at least one of the corners are substantially coincident.

12. The magnetic connector apparatus of claim 9 wherein an opening is defined in the center of at least one of the magnetic connector body.

13. The magnetic connector apparatus of claim 9 wherein each of the magnetic connector bodies is comprised of two sections that snap together.

14. The magnetic connector apparatus of claim 13 wherein each of the two sections have internal strengthening ribs.

15. The magnetic connector apparatus of claim 9 wherein the bodies are used to represent chemical atoms with at least one of:
a letter printed on the bodies denoting atom type;
a shape of the bodies denoting atom type; and
a surface finish of the bodies denoting atom type.

16. A method to manufacture a magnetic connector apparatus, comprising:
fabricating two sections of a polygonal connector body, each of the two sections having hemispherical sockets defined in at least three corners of each section of the polygonal connector body;
placing spherical magnets into the hemispherical socket portions in a first of the two sections, the spherical magnets are free to rotate within their respective sockets around and x-axis, a y-axis, a z-axis, and any combination of the x, y, and z axes; and
positioning a second of the two sections over the first section such that the hemispherical socket portions of the two sections are mutually aligned; and
placing the second of the two sections on the first section.

17. The method of claim 16 wherein each of the two sections having a plurality of receptacles and pins; and when placing the second of the two sections on the first section, a first of the pins of the first section engages with a first of the receptacles of the second section and a first of the receptacles of the first section engages with a first of the pins of the second section.

18. The method of claim 16 wherein the two sections of the polygonal connector body are fabricated by injection molding.

19. The method of claim 16 wherein an opening is defined in the center section of the polygonal connector body to thereby reduce the amount of material used in fabricating the polygonal connector body.

20. The method of claim 16 wherein the sections of the polygonal connector body has a plurality of internal strengthening ribs.
